(19) United States
(12) Patent Application Publication
(10) Pub. No.: US 2016/0376002 A1
(43) Pub. Date: Dec. 29, 2016

(54) Aircraft with Rotating Outer Shell

(71) Applicant: Robert Davidson, Saskatoon (CA)

(72) Inventor: Robert Davidson, Saskatoon (CA)

(21) Appl. No.: 14/626,209

(22) Filed: Feb. 19, 2015

(51) Int. Cl. B64C 39/00; B64C 29/00; B64C 15/02; B64C 1/16; B64C 17/06

(52) U.S. Cl. CPC B64C 39/001; B64C 1/16; B64C 17/06; B64C 15/02; B64C 29/0041; B64C 2001/0045

(57) ABSTRACT

An aircraft having a main body defining a passenger compartment therein, an upper shell portion above the main body and a lower shell portion below the main body, further includes a motor assembly operatively connected between the upper shell portion, the lower shell portion and the main body so as to be arranged to drive rotation of the upper and lower shell portions relative to the main body in opposing directions relative to one another. An engine assembly is supported on the main body in communication with a central thrust opening in the lower shell portion so as to be arranged to provide upward thrust to the main body.

### FIELD OF THE INVENTION

The present invention relates to an aircraft having a generally circular main body locating a passenger compartment therein in which an outer surface of the aircraft is formed of an upper shell and a lower shell which counter-rotate relative to the main body.

### BACKGROUND

The design of aircraft which is stable in-flight yet remains highly manoeuvrable and makes efficient use of power is known to be desirable. Various attempts at designing improved aircraft are disclosed in the following prior US patents. U.S. Pat. No. 5,213,284 belonging to Webster; U.S. Pat. No. 5,259,571 belonging to Blazquez; U.S. Pat. No. 4,807,830 belonging to Horton; U.S. Pat. No. 2,935,275 belonging to Grayson; U.S. Pat. No. 5,064,143 belonging to Bucher and U.S. Pat. No. 5,072,892 belonging to Carrington.

Some attempts to improve stability of aircraft in the prior art include the use of rotating auxiliary masses on the aircraft body to provide a gyroscopic effect. The use of such additional masses however decreases the overall efficiency of the aircraft due to the extra power being lost to lift the auxiliary mass against the force of gravity.

Further attempts to improve aircraft according to the prior art include the use of vertical thrust fans for improving manoeuvrability and vertical take-off ability, however such known attempts generally have a negative effect on the overall aerodynamics of the body of the aircraft during horizontal flight resulting in a loss in efficiency in propelling the vehicle in a forward lateral motion.

### SUMMARY OF THE INVENTION

According to one aspect of the invention there is provided an aircraft comprising:

a main body defining a passenger compartment therein which is arranged to receive a plurality of passengers therein;

an upper shell portion supported on the main body so as to be rotatable relative to the main body about a vertically oriented central axis of the main body, the upper shell portion spanning radially outward from the central axis across a top side of the main body to an outer perimeter edge of the upper shell portion;

a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;

a motor assembly operatively connected between the upper shell portion, the lower shell portion and the main body so as to be arranged to drive rotation of the upper and lower shell portions relative to the main body in opposing directions relative to one another;

the lower shell portion including a lower thrust opening communicating therethrough at the central axis of the main body; and

an engine assembly supported on the main body in communication with the lower thrust opening and being arranged to provide upward thrust to the main body.

The above noted construction permits the upper and lower shell portions to define a majority of the outer surface of the aircraft so that when they are rotating they have the effect of reducing air drag when the aircraft is displaced horizontally relative to the ground in a forward direction. The effect is particularly beneficial when the lower thrust opening is the only opening in the upper and lower shells. The rotating shell portions also have the benefit of providing some stability to the aircraft by gyroscopic effect.

Preferably the upper shell portion is fully enclosed and fully spans a top side of the main body between the central axis of the main body and the outer perimeter edge of the upper shell portion.

Preferably the lower shell portion fully spans a bottom side of the main body and is fully enclosed between the lower thrust opening and the outer perimeter edge of the lower shell portion.

The upper shell portion preferably further includes a flange portion extending radially inward from the outer perimeter edge of the upper shell portion in overlapping configuration relative to the outer perimeter edge of the lower shell portion.

Preferably the engine assembly provides sole thrust during take-off.

Preferably the aircraft further comprises at least one idler wheel supported in rolling contact with both the upper shell portion thereabove and the lower shell portion therebelow, in which the motor assembly directly drives rotation of one of the shell portions and another one of the shell portions is driven to rotate by said at least one idler wheel.

Preferably the motor assembly is connected to the upper shell portion adjacent to a top side of the main body and directly drives the upper shell portion relative to the main body.

Preferably there is provided a plurality of the idler wheels at evenly spaced positions in a circumferential direction.

Preferably the idler wheels are supported on the main body for free floating movement relative to the main body in a vertical direction.

Preferably each idler wheel is a pneumatically inflated wheel of resilient material, for example a rubber tire.

Preferably each idler wheel is in rolling contact with both an annular bearing surface on the upper shell portion in proximity to the outer perimeter edge thereof and an annular bearing surface on the lower shell portion in proximity to the outer perimeter edge thereof.

When the upper and lower shell portions are vertically adjustable relative to one another, preferably at least one hydraulic actuator acts between the upper and lower shell portions so as to be arranged to apply a hydraulic clamping force to diametrically opposed sides of said at least one idler wheel.

When the upper shell portion is vertically adjustable in position relative to the main body, preferably an upper support member is vertically slidable relative to the main body adjacent the top end thereof at the central axis, and a plurality of bearings are coupled between the upper support member and the upper shell portion.

Preferably a linear acting hydraulic actuator is coupled between the upper support member and the main body to control vertical position of the upper shell portion relative to the main body.

There may also be provided i) a gear supported on one of the main body and the upper shell portion, ii) a rack supported on the other one of the main body and the upper shell portion in meshing engagement with the gear as the upper shell portion is vertically adjusted relative to the main body, and iii) a lock member arranged to selectively engaged between the gear and the lock so as to lock the vertical position of the upper shell portion relative to the main body at a selected position.

When the lower shell portion is vertically adjustable relative to the main body. preferably a lower support member is supported on the main body at a bottom end thereof for vertical sliding movement at the central axis, and a plurality of bearings are coupled between the lower support member and the lower shell portion along an annular path about the lower thrust opening.

According to a second aspect of the present invention there is provided an aircraft comprising:

a main body defining a passenger compartment therein which is arranged to receive a plurality of passengers therein;

an upper shell portion supported on the main body so as to be rotatable relative to the main body about a vertically oriented central axis of the main body, the upper shell portion spanning radially outward from the central axis across a top side of the main body to an outer perimeter edge of the upper shell portion;

a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;

a motor assembly operatively connected between the upper shell portion, the lower shell portion and the main body so as to be arranged to drive rotation of the upper and lower shell portions relative to the main body in opposing directions relative to one another;

the lower shell portion including a lower thrust opening communicating therethrough at the central axis of the main body; and

an engine assembly supported on the main body in communication with the lower thrust opening and being arranged to provide upward thrust to the main body;

the upper shell portion being fully enclosed and fully spanning a top side of the main body between the central axis of the main body and the outer perimeter edge of the upper shell portion;

the lower shell portion fully spanning a bottom side of the main body and being fully enclosed between the lower thrust opening and the outer perimeter edge of the lower shell portion; and

an outer surface of the aircraft being fully defined by the upper shell portion and the lower shell portion such that the lower thrust opening is the only opening in the outer surface.

According to a further aspect of the present invention there is provided an aircraft comprising:

a main body defining a passenger compartment therein which is arranged to receive a plurality of passengers therein;

an upper shell portion supported on the main body so as to be rotatable relative to the main body about a vertically oriented central axis of the main body, the upper shell portion spanning radially outward from the central axis across a top side of the main body to an outer perimeter edge of the upper shell portion;

a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;

a motor assembly connected to the upper shell portion so as to be arranged to drive rotation of the upper shell portion relative to the main body;

at least one idler wheel supported in rolling contact with both the upper shell portion thereabove and the lower shell portion therebelow such that the lower shell portion is driven to rotate relative to the main body in an opposing direction relative to the upper shell portion as the upper shell portion is driven to rotate relative to the main body;

the lower shell portion including a lower thrust opening communicating therethrough at the central axis of the main body; and

an engine assembly supported on the main body in communication with the lower thrust opening and being arranged to provide upward thrust to the main body.

One embodiment of the invention will now be described in conjunction with the accompanying drawings in which:

### BRIEF DESCRIPTION OF THE DRAWINGS

FIG. 1 is a side elevational view of the aircraft.

FIG. 2 is a top plan view of the aircraft.

FIG. 3 is a vertical cross section through a central axis of the aircraft.

FIG. 4 is a partly sectional view along the line 4-4 of FIG. 3.

FIG. 5 is a vertical cross section of an alternative embodiment of the motor assembly.

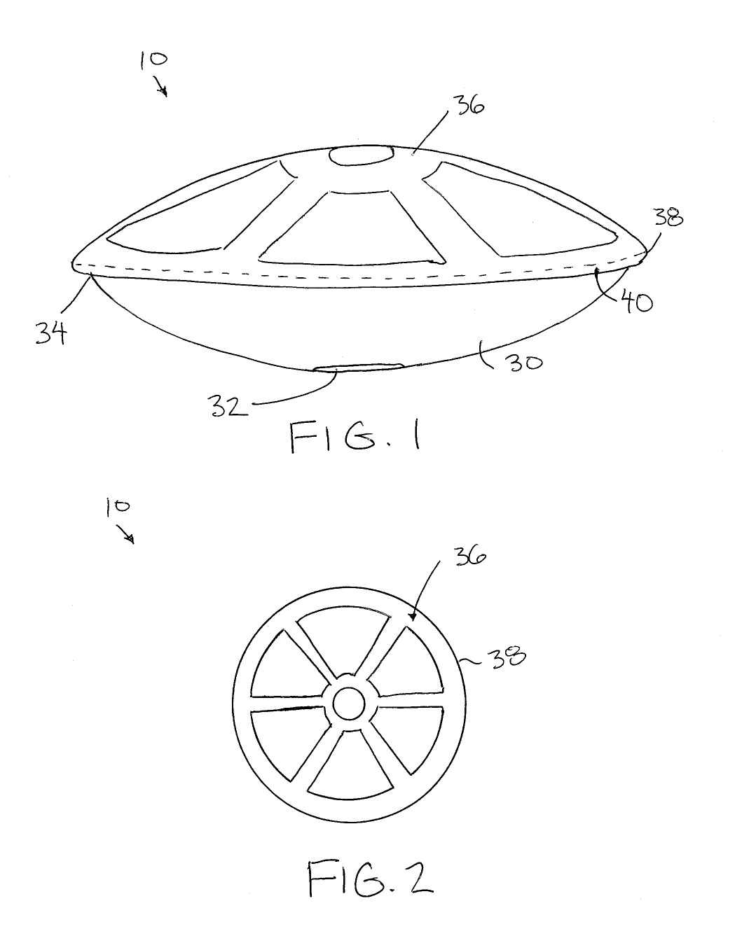

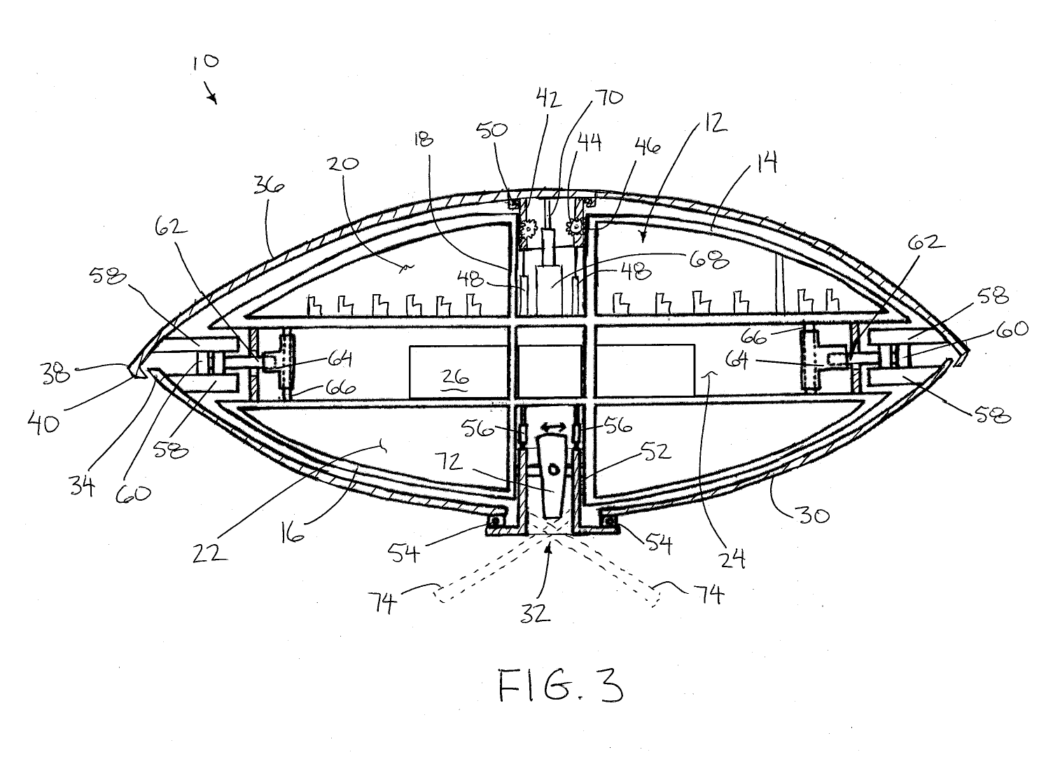

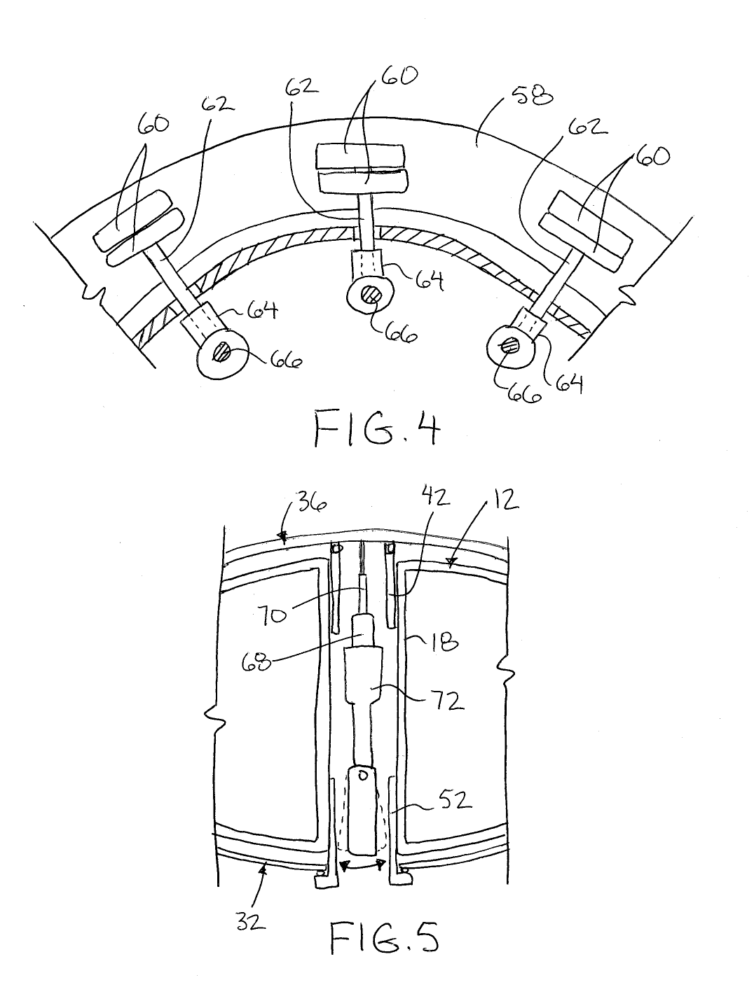

In the drawings like characters of reference indicate corresponding parts in the different figures.

### DETAILED DESCRIPTION

Referring to the accompanying figures, there is illustrated an aircraft generally indicated by reference numeral 10. The aircraft is generally circular in plan view and has an outer surface with a profile providing the function of an airfoil to provide lift to the aircraft when the aircraft is displaced horizontally relative to the ground. Furthermore, the outer surface of the aircraft includes rotating portions providing the function of reducing drag and air resistance when displaced in the forward direction. The aircraft further includes auxiliary thrust in addition to the airfoil shape of the outer surface to provide the sole vertical thrust for takeoff and landing as well as to assist in sustaining flight. The auxiliary thrust can be used to provide steering as well. The auxiliary thrust is exhausted through the bottom of the aircraft at a central location.

The aircraft 10 generally comprises a main body 12 formed of a rigid structure which is generally circular about a vertically oriented central axis of the aircraft. The main body has an upper wall 14 having a convex top side defining the upper boundary of the main body and a lower wall 16 having a convex bottom side which defines the lower boundary of the main body. Various frame members and partition walls are connected between the upper wall and the lower wall to divide the hollow interior of the main body into a plurality of different compartments and different elevations.

A tubular wall 18 is provided which spans vertically between the upper and lower walls concentric with the central axis of the aircraft to define a central chamber therein which is elongate in a vertical direction. The central chamber serves to locate various mechanical equipment therein as described in further detail below.

The main body further locates an upper annular compartment 20 therein adjacent the top end, a lower annular compartment 22 adjacent the bottom end, and an intermediate compartment 24 situated between the upper and lower compartments. Each of the compartments is generally annular in shape about the central chamber and occupies the radial space between the central chamber and the outer perimeter of the main body. Each of the compartments is suited for housing therein any one of i) the passengers of the aircraft, ii) cargo, or iii) mechanical equipment including fuel tanks for example.

In the illustrated embodiment, the upper compartment 20 comprises a passenger compartment locating seating for numerous passengers, for example four or more, and the operating crew of the aircraft in respective partitioned sections of the upper compartment respectively. The lower compartment in the illustrated embodiment is used for storing cargo therein including luggage and the like for example. A fuel tank 26 and various mechanical equipment to be described in further detail below are located in the intermediate compartment in the illustrated embodiment. Special insulation is provided in the walls separating the jet motor from the fuel tank to isolate heat.

The aircraft further includes a lower shell 30 supported to span the bottom side of the main body while being rotatable relative to the main body about the central axis of the aircraft. The lower shell locates a lower thrust opening 32 centrally therein so as to be concentric about the central axis. The remainder of the lower shell is fully enclosed to fully span in the radial direction from the perimeter of the opening 32 to a perimeter edge 34 of the lower shell which is circular and in proximity to the outer perimeter of the aircraft. The lower shell defines the bottom outer surface of the aircraft.

Similarly, an upper shell 36 is supported on the main body to fully span the top side of the body while being rotatable relative to the main body about the central axis. The upper shell 36 fully spans the top side of the aircraft from the central axis to a respective perimeter edge 38 at the outer perimeter of the aircraft, and adjacent to the perimeter edge of the lower shell 30.

The upper shell closely follows the profile of the top side of the main body so as to have a convex outer surface. Similarly, the lower shell closely follows the profile of the bottom side of the main body so as to have a convex outer side.

The outer shell further includes a lower flange 40 which extends downwardly and radially inwardly from the perimeter edge of the upper shell in overlapping arrangement relative to an outer edge portion of the lower shell at the perimeter edge thereof. A small gap remains between the upper and lower shells at the perimeter of the aircraft however due to the overlapping of the upper shell relative to the lower shell. The upper and lower shells collectively define the entirety of the outer surface of the aircraft.

To provide visibility for passengers within the upper compartment, both the top wall of the main body 12 and the upper shell may include transparent viewing panes mounted integrally therein which can be aligned with one another to define windows which permit viewing therethrough from the interior of the upper compartment to the exterior of the aircraft. Alternatively you could eliminate windows by using cameras on the upper edge of the center tube compartment. A camera could also be placed on the lower edge of the center tube compartment. The cameras could be movable or stationary and multidirectional, for example by capturing images in four different directions.

The upper shell portion is rotatably supported on the main body by a support sleeve 42 which is vertically slidable within the top end of the tubular wall 18 of the main body. A suitable set of gears 44 and a rack 46 may be supported in meshing engagement with one another on respective ones of the support sleeve 42 and the tubular wall of the main body 12 for controlling the relative vertical sliding therebetween and for locking the vertical position of the sleeve relative to the main body at a selected position. The meshing gear and rack may be used simply for guiding purposes and/or for locking the set position. The relative vertical movement can be controlled by a plurality of hydraulic actuators 48 coupled for linear movement between the support sleeve 42 and the main body of the housing. Suitable bearings 50 are coupled about the top end of the support sleeve 42 to provide rotatable connection between the top of the support sleeve and the upper shell along an annular path about the central chamber defined by tubular wall 18.

The lower shell is similarly supported for rotation relative to the bottom of the main body by a respective support sleeve 52 which is vertically slidable within the tubular wall 18 of the main body at the bottom end thereof. Annular bearings 54 are supported between respective bearing surfaces 56 at the bottom end of the support sleeve 52 and on the lower shell 30 about the perimeter edge of the lower thrust opening 32. The support sleeves are each concentric about the central vertical axis of the aircraft. Similarly to the upper support sleeve, the lower support sleeve 52 and the lower shell supported thereon by the bearings are controlled in vertical position relative to the main body by hydraulic actuators 56 which are linear acting in a vertical direction and which are coupled at circumferentially spaced positions between the main body and the support sleeve.

The upper and lower shells are also supported relative to the main body and relative to one another in proximity to their outer perimeter edge in addition to the bearings at the central axis. In particular, each shell includes an annular running surface 58 comprising a horizontal surface extending radially inward from an interior side of the shell in alignment with the intermediate compartment 24 in proximity to the outer perimeter edge. In the illustrated embodiment, the running surfaces are defined by respective flanges which are vertically spaced apart from one another in parallel relationship so that the running surface 58 of the upper shell is defined as the bottom surface of the corresponding flange and the running surface 58 of the lower shell is defined as the top side of the corresponding flange. A plurality of idler wheels 60 are supported at circumferentially spaced positions on the main body so as to be received between the running surfaces 58 of the upper and lower shells in rolling contact therewith.

In some embodiments, each idler wheel 60 is a pneumatically inflated rubber tire which is rotatable relative to the main body about a respective radial axis, extending radially outward from the central axis. Each idler wheel is supported on a radially oriented shaft 62 which supports the idler wheel on the outer end of the shaft. The radial shaft is supported by suitable bearings on a respective sleeve 64 which is supported for vertically sliding movement along a respective post 66 which is mounted vertically and in fixed relation to the main body 12. The bearing sleeve 64 of each idler wheel is arranged to float generally at a central location along its respective post which in turn locates the idler wheel 60 at the outer end thereof between the running surfaces of the upper and lower shells respectively.

The diameter of the idler wheels determine the distance between the upper rotating shell and the main body, as well as the distance between the two rotating shells. The idlers move up and down on their vertically movable supports while the wheels maintain separation between the rotating shells, with the distance being controlled to ensure that the upper rotating shell clears the main body.

In further embodiments, the idler wheels may be solid rubber instead of being air filled because of the accuracy needed to work out the dimensions between the main body and the upper shell, as well as between the upper and lower shells.

By applying variable hydraulic pressure to the hydraulic actuators of either one of the upper shell or the lower shell, the vertical position of each shell relative to the main body can be adjusted and the overall hydraulic pressure can be adjusted such that the pressure of the two running surfaces 58 clamped against diametrically opposing sides of the idler wheels 60 controls how much frictional gripping is provided by the idler wheels between the running surfaces.

To drive the rotation of the upper and lower shells relative to the main body, a single motor 68 is supported in the upper portion of the central chamber defined by the tubular wall 18. The motor includes a vertical output shaft extending upwardly therefrom in connection to the upper shell at the top end thereof at the central axis. The drive shaft 70 comprises a telescopic shaft permitting the length of the drive shaft to be adjusted as the position of the upper shell relative to the main body is adjusted. The motor thus serves to directly drive rotation of the upper shell relative to the main body. Rotation of the lower shell relative to the main body is accomplished by transferring drive through the idler wheels 60.

The aircraft further includes an engine assembly 72 supported in the central chamber adjacent the bottom end thereof for communicating through the lower thrust opening in the lower shell. The engine assembly may include a jet engine which receives fuel from the fuel tank in the intermediate compartment in which the engine is directed downwardly to provide downward thrust and thus upward lift to the aircraft. The engine assembly is mounted for pivotal adjustment about a vertical axis and a horizontal axis to permit the thrust to be directed off of the vertical axis in any direction for steering and for forward thrust. Air can be supplied to the jet engine through a periphery of the lower thrust opening, or alternatively through an inlet at a central location in the upper shell to be ducted downwardly through the central chamber defined by the tubular wall 18. Alternatively, air can be supplied to the engine through the peripheral gap between the upper and lower shells.

A set of landing gear legs can be mounted on the main body to communicate telescopically through the lower thrust opening for supporting the aircraft thereon when landing.

In some instances a single engine may be provided which provides both the downward thrust through the lower thrust opening as well as permitting some power to be taken off from the engine for supplying the motor assembly 68 with the input force required to rotate the upper and lower shells as shown in the alternative arrangement of FIG. 5. More preferably a separate engine is provided for connection to the motor which drives rotation of the shells relative to the jet engine providing vertical thrust at the bottom of the aircraft.

In use, the aircraft is initially supported on the ground by telescopic legs. When preparing for take-off, the upper and lower shells are driven to rotate and the engine is activated to provide downward thrust through the lower thrust opening for vertical take-off of the aircraft. Tilting the engine assembly 72 off axis permits the aircraft to be propelled forwardly or steered in any direction. Once the aircraft has taken off, the legs can be telescopically retracted up into the main body within the perimeter boundary of the lower shell. Once the aircraft begins to be displaced horizontally across the ground, the shape of the aircraft can assist in providing some lift which complements the downward thrust of the engine assembly 72.

Special heat insulating tile is provided on the lower surface of the lower shell because of back splash of the jet exhaust. A special heat resistant launching pad may also be used onto which jet exhaust is directed during lift off, similar to rocket launching pads.

The heat insulating tile on the lower surface of the lower shell is also useful for deflecting heat away from the passenger compartment in instances where the aircraft is capable of leaving earth's atmosphere and the lower surface is the leading surface of the aircraft during re-entry.

Since various modifications can be made in my invention as herein above described, and many apparently widely different embodiments of same made, it is intended that all matter contained in the accompanying specification shall be interpreted as illustrative only and not in a limiting sense.

1. An aircraft comprising:
a main body defining a passenger compartment therein which is arranged to receive a plurality of passengers therein;
an upper shell portion supported on the main body so as to be rotatable relative to the main body about a vertically oriented central axis of the main body, the upper shell portion spanning radially outward from the central axis across a top side of the main body to an outer perimeter edge of the upper shell portion;
a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;
a motor assembly operatively connected between the upper shell portion, the lower shell portion and the main body so as to be arranged to drive rotation of the upper and lower shell portions relative to the main body in opposing directions relative to one another;
the lower shell portion including a lower thrust opening communicating therethrough at the central axis of the main body; and
an engine assembly supported on the main body in communication with the lower thrust opening and being arranged to provide upward thrust to the main body.

2. The aircraft according to claim 1 wherein the upper shell portion is fully enclosed and fully spans a top side of the main body between the central axis of the main body and the outer perimeter edge of the upper shell portion.

3. The aircraft according to claim 1 wherein the lower shell portion fully spans a bottom side of the main body and is fully enclosed between the lower thrust opening and the outer perimeter edge of the lower shell portion.

4. The aircraft according to claim 1 wherein the upper shell portion includes a flange portion extending radially inward from the outer perimeter edge of the upper shell portion in overlapping configuration relative to the outer perimeter edge of the lower shell portion.

5. The aircraft according to claim 1 wherein the engine assembly provides sole thrust during take-off.

6. The aircraft according to claim 1 further comprising at least one idler wheel supported in rolling contact with both the upper shell portion thereabove and the lower shell portion therebelow, wherein the motor assembly directly drives rotation of one of the shell portions and another one of the shell portions is driven to rotate by said at least one idler wheel.

7. The aircraft according to claim 6 wherein the motor assembly is connected to the upper shell portion adjacent to a top side of the main body and directly drives the upper shell portion relative to the main body.

8. The aircraft according to claim 6 wherein said at least one idler wheel comprises a plurality of idler wheels at evenly spaced positions in a circumferential direction.

9. The aircraft according to claim 6 wherein said at least one idler wheel is supported on the main body for free floating movement relative to the main body in a vertical direction.

10. The aircraft according to claim 6 wherein said at least one idler wheel comprises a pneumatically inflated wheel of resilient material.

11. The aircraft according to claim 6 wherein said at least one idler wheel is in rolling contact with both an annular bearing surface on the upper shell portion in proximity to the outer perimeter edge thereof and an annular bearing surface on the lower shell portion in proximity to the outer perimeter edge thereof.

12. The aircraft according to claim 6 wherein the upper and lower shell portions are vertically adjustable relative to one another and wherein there is provided at least one hydraulic actuator acting between the upper and lower shell portions so as to be arranged to apply a hydraulic clamping force to diametrically opposed sides of said at least one idler wheel.

13. The aircraft according to claim 1 wherein the upper shell portion is vertically adjustable in position relative to the main body.

14. The aircraft according to claim 13 further comprising an upper support member vertically slidable relative to the main body adjacent the top end thereof at the central axis and a plurality of bearings coupled between the upper support member and the upper shell portion.

15. The actuator according to claim 14 further comprising a hydraulic actuator which is linear acting and which is coupled between the upper support member and the main body to control vertical position of the upper shell portion relative to the main body.

16. The aircraft according to claim 13 further comprising a gear supported on one of the main body and the upper shell portion, a rack supported on the other one of the main body and the upper shell portion in meshing engagement with the gear as the upper shell portion is vertically adjusted relative to the main body, and a lock member arranged to selectively engaged between the gear and the lock so as to lock the vertical position of the upper shell portion relative to the main body at a selected position.

17. The aircraft according to claim 1 wherein the lower shell portion is vertically adjustable relative to the main body.

18. The aircraft according to claim 17 further comprising a lower support member which is supported on the main body at a bottom end thereof for vertical sliding movement at the central axis, and bearings coupling the lower support member to the lower shell portion along an annular path about the lower thrust opening.

19. An aircraft comprising:
a main body defining a passenger compartment therein which is arranged to receive a plurality of passengers therein;
an upper shell portion supported on the main body so as to be rotatable relative to the main body about a vertically oriented central axis of the main body, the upper shell portion spanning radially outward from the central axis across a top side of the main body to an outer perimeter edge of the upper shell portion;
a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;
a motor assembly operatively connected between the upper shell portion, the lower shell portion and the main body so as to be arranged to drive rotation of the upper and lower shell portions relative to the main body in opposing directions relative to one another;
the lower shell portion including a lower thrust opening communicating therethrough at the central axis of the main body; and
an engine assembly supported on the main body in communication with the lower thrust opening and being arranged to provide upward thrust to the main body;
the upper shell portion being fully enclosed and fully spanning a top side of the main body between the central axis of the main body and the outer perimeter edge of the upper shell portion;
the lower shell portion fully spanning a bottom side of the main body and being fully enclosed between the lower thrust opening and the outer perimeter edge of the lower shell portion; and
an outer surface of the aircraft being fully defined by the upper shell portion and the lower shell portion such that the lower thrust opening is the only opening in the outer surface.

20. An aircraft comprising:
a main body defining a passenger compartment therein which is arranged to receive a plurality of passengers therein;
an upper shell portion supported on the main body so as to be rotatable relative to the main body about a vertically oriented central axis of the main body, the upper shell portion spanning radially outward from the central axis across a top side of the main body to an outer perimeter edge of the upper shell portion;
a lower shell portion supported on the main body so as to be rotatable relative to the main body about the central axis of the main body, the lower shell portion spanning radially outward from the central axis across a bottom side of the main body to an outer perimeter edge of the lower shell portion which is in proximity to the outer perimeter edge of the upper shell portion;
a motor assembly connected to the upper shell portion so as to be arranged to drive rotation of the upper shell portion relative to the main body;
at least one idler wheel supported in rolling contact with both the upper shell portion thereabove and the lower shell portion therebelow such that the lower shell portion is driven to rotate relative to the main body in an opposing direction relative to the upper shell portion as the upper shell portion is driven to rotate relative to the main body;
the lower shell portion including a lower thrust opening communicating therethrough at the central axis of the main body; and
an engine assembly supported on the main body in communication with the lower thrust opening and being arranged to provide upward thrust to the main body.
